(19) United States
(12) Patent Application Publication
(10) Pub. No.: US 2010/0232852 A1
(43) Pub. Date: Sep. 16, 2010

(54) TONER CONVEYING MECHANISM, CLEANING UNIT INCLUDING THE SAME, AND IMAGE FORMING APPARATUS

(75) Inventor: Terumitsu Noso, Osaka (JP)

Correspondence Address: FROMMER LAWRENCE & HAUG, 745 FIFTH AVENUE- 10TH FL., NEW YORK, NY, 10151, US

(73) Assignee: KYOCERA MITA CORPORATION, Osaka (JP)

(21) Appl. No.: 12/700,365

(22) Filed: Feb. 4, 2010

(30) Foreign Application Priority Data
Mar. 10, 2009 (JP) 2009-056161

(51) Int. Cl. G03G 21/00

(52) U.S. Cl. 399/358

(57) ABSTRACT

An embodiment of a toner conveying mechanism may include a housing, a conveying member, and a protrusion. In some embodiments, the housing configured to hold toner. An embodiment of a conveying member may be disposed in the housing and may be configured to convey the toner by rotation. In some embodiments, a protrusion may be disposed on the surface of the inner wall of the housing. An embodiment of the protrusion may protrude toward the conveying member. In some embodiments, the protrusion may intermittently contact the conveying member during rotation of the conveying member.

### INCORPORATION BY REFERENCE

This application is based upon and claims the benefit of priority from the corresponding Japanese Patent application No. 2009-56161, filed Mar. 10, 2009, the entire content of which is incorporated herein by reference.

### FIELD OF THE INVENTION

The present invention relates to a toner conveying mechanism applicable to an image forming apparatus including, but not limited to a copying machine, a printer, or a Multifunction Peripheral. An embodiment relates to a cleaning unit including the toner conveying mechanism and an image forming apparatus.

### BACKGROUND OF THE INVENTION

In image forming apparatuses, such as copying machines, printers, and Multifunction Peripheral (hereinafter “MFP”), a photosensitive drum is widely used as an image bearing member. A general image forming operation using the photosensitive drum is as follows: The surface of the photosensitive drum is uniformly charged to a predetermined potential by a charging unit and is irradiated with LED light or the like by an exposure unit, so that the potential is partly attenuated to form an electrostatic latent image of an original image. This electrostatic latent image is developed by a developing unit into a toner image. After the toner image is transferred onto paper, toner remaining on the surface of the photosensitive drum is removed by a cleaning unit, and the electric charge is removed by applying antistatic light from a static eliminator for the next image forming operation.

Of the components of the image forming apparatus that executes the image forming operation as described above, the cleaning unit is configured to temporarily store the toner removed from the surface of the photosensitive drum as waste toner into the housing of the cleaning unit. Since this waste toner is successively removed from the surface of the photosensitive drum into the housing of the cleaning unit during the image forming operation, the waste toner needs to be discharged to the exterior to prevent the interior of the housing from being filled with the waste toner. Thus, the cleaning unit widely employs a toner conveying mechanism equipped with a spiral- or screw-shaped conveying member that conveys the waste toner by rotation, for moving the waste toner to a collecting container by the rotating motion of the conveying member.

The developing unit is configured such that a predetermined amount of toner is constantly stored in the housing thereof. To achieve high-quality image formation, the toner stored in the housing needs to be uniformly dispersed along the length of a developing roller in the housing. Thus, the developing unit widely employs a toner conveying mechanism equipped with a stirring conveying member in a spiral or screw shape, like the above-described cleaning unit, for stirring and conveying the toner by rotation, and uniformly dispersing the toner while moving along the length of the housing by the rotating motion.

Here, if the toner stays in the cleaning unit or the developing unit for a long period or if the temperature around these units rises, the liquidity of the toner in the housing is decreased to pose the risk of sticking the toner onto the surface of the toner conveying member. If the toner is stuck onto the conveying member and is deposited, the toner conveying performance may be significantly decreased, and waste toner in the cleaning unit can overflow to stain the periphery, or the waste toner can again stick to the surface of the photosensitive drum to decrease the cleaning performance. In the developing unit, a toner image developed on the surface of the photosensitive drum may be affected to cause a defect in an image formed on the paper. Furthermore, the rotation of the conveying member is stopped, so that the conveying member, the inner wall of the housing, and the other components inside the housing can be damaged.

To solve such problems, the toner collecting mechanism (toner conveying mechanism) of the cleaner unit (cleaning unit) proposed to prevent toner from sticking to the surface of the conveying member is equipped with a driving unit that vibrates a toner conveying coil (conveying member) at the upstream end of the conveying coil in the toner conveying direction.

The above-described cleaner unit can prevent toner from sticking to the surface of the toner conveying coil or being seized thereon by striking the upstream end of the toner conveying coil in the conveying direction to vibrate the conveying coil, thereby enhancing the toner conveying performance. However, with this toner conveying mechanism, the location at which the conveying coil is struck is outside a toner conveying pipe, so that the striking sound is prone to echo to the exterior of the image forming apparatus. This has a high possibility that the striking sound of the conveying coil provides uncomfortable feeling to the user as noise.

### SUMMARY OF THE INVENTION

In an embodiment, a toner conveying mechanism may include a housing configured to receive toner; a conveying member disposed in the housing and configured to convey the toner by rotation; and a protrusion disposed on the inner wall surface of the housing. In various embodiments, the housing may be configured to contain the toner within the housing. In some embodiments, the protrusion may protrude toward the conveying member. Thus, in an embodiment the conveying member may contact the protrusion intermittently during rotation of the conveying member.

An embodiment of a cleaning unit may include a cleaning member, a housing, a conveying member, and a protrusion. In some embodiments a cleaning member may be configured to remove toner from a photoreceptor. An embodiment of a housing may be configured to contain the toner removed by the cleaning member within the housing. In some embodiments, a conveying member may be disposed in the housing and configured to convey the toner by rotation. Some embodiments of a protrusion may be disposed on the inner wall surface of the housing and protrude toward the conveying member. In some embodiments, the conveying member may intermittently contact the protrusion when the conveying member rotates.

An embodiment of an image forming apparatus may include a photoreceptor, a developing unit, a transfer unit, a cleaning member, a housing, and a protrusion. In some embodiments, an electrostatic latent image is formed on a photoreceptor based on a document image. An embodiment of a developing unit may be configured to form a toner image on the photoreceptor by developing the electrostatic latent image formed on the photoreceptor with toner. Some embodiments of a transfer unit may be configured to transfer the toner image formed on the photoreceptor by the developing unit to a recording medium. In an embodiment, a cleaning member may be configured to remove the toner remaining on the photoreceptor from the photoreceptor after the toner image is transferred to the transfer unit. An embodiment may include a housing configured to receive the toner removed by the cleaning member. In various embodiments, the housing may be configured to contain the toner within the housing. In some embodiments, a conveying member may be disposed in the housing and configured to convey the toner by rotation. An embodiment may include a protrusion disposed on the inner wall surface of the housing and protruding toward the conveying member. The conveying member may come into intermittent contact with the protrusion, when the conveying member rotates.

The above and other objects, features, and advantages of the present invention will be more apparent from the following detailed description of embodiments taken in conjunction with the accompanying drawings.

In this text, the terms “comprising”, “comprise”, “comprises” and other forms of “comprise” can have the meaning ascribed to these terms in U.S. Patent Law and can mean “including”, “include”, “includes” and other forms of “include”.

Various features of novelty which characterize the invention are pointed out in particularity in the claims annexed to and forming a part of this disclosure. For a better understanding of the invention, its operating advantages and specific objects attained by its uses, reference is made to the accompanying descriptive matter in which exemplary embodiments of the invention are illustrated in the accompanying drawings in which corresponding components are identified by the same reference numerals.

### BRIEF DESCRIPTION OF THE DRAWINGS

The following detailed description, given by way of example, but not intended to limit the invention solely to the specific embodiments described, may best be understood in conjunction with the accompanying drawings, in which:

FIG. 1 is a schematic of the front view of a vertical section of an image forming apparatus equipped with a toner conveying mechanism according to an embodiment of the present invention;

FIG. 2 is a schematic showing an enlarged front view of a vertical sectional of the periphery of an image forming unit in FIG. 1;

FIG. 3 is a schematic of a back view of a vertical sectional of the image forming apparatus in FIG. 1;

FIG. 4 is a schematic of a vertical sectional of the back view of the toner conveying mechanism in FIG. 3;

FIG. 5 is a schematic of partially enlarged vertical section of the back view of the toner conveying mechanism in FIG. 4; and

FIG. 6 is a schematic of a partially enlarged vertical section of the back view of the toner conveying mechanism as is shown in FIG. 5, showing a state in which a conveying spiral is in contact with a protrusion.

FIG. 7 is a schematic of a partially enlarged section of the toner conveying mechanism depicting a wall of the housing, a discharge screw, and a protrusion.

### DETAILED DESCRIPTION OF THE EMBODIMENTS

Reference will now be made in detail to various embodiments of the invention, one or more examples of which are illustrated in the accompanying drawings. Each example is provided by way of explanation of the invention, and by no way limiting the present invention. In fact, it will be apparent to those skilled in the art that various modifications, combinations, additions, deletions and variations can be made in the present invention without departing from the scope or spirit of the present invention. For instance, features illustrated or described as part of one embodiment can be used in another embodiment to yield a still further embodiment. It is intended that the present invention covers such modifications, combinations, additions, deletions, applications and variations that come within the scope of the appended claims and their equivalents.

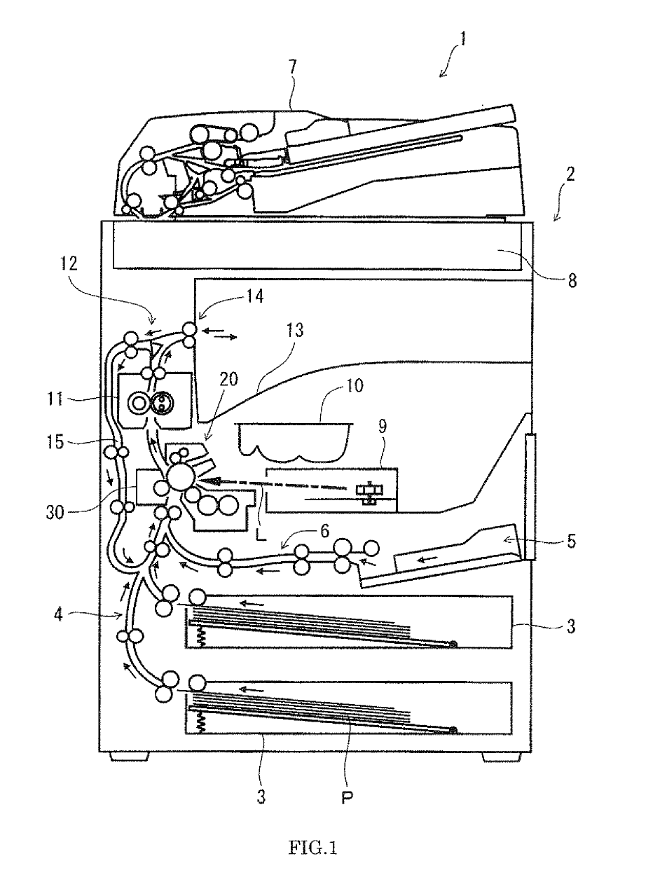

An embodiment of the present invention will be described with reference to FIGS. 1 to 6.

Referring to FIG. 1, the image output operation of an embodiment of image forming apparatus 1 equipped with a toner conveying mechanism will be described while explaining, in outline, the configuration thereof. FIG. 1 is a schematic view of a vertical section of the front of image forming apparatus 1. In FIG. 1, solid-line arrows indicate a paper conveying path and/or conveying direction, and a chain-line arrow indicates a laser beam L.

As shown in FIG. 1, paper cassette 3 may serve as a paper feeding unit. An embodiment may include paper cassette 3 disposed at a lower part in main body 2 of image forming apparatus 1. In some embodiments, paper cassette 3 may accommodate stacked paper P, such as cut paper before printed. The paper P may be separated one by one and fed to the upper left of paper cassette 3 in FIG. 1. In some embodiments, paper cassette 3 can be withdrawn from the front of main body 2 in a horizontal direction.

In some embodiments, as shown in FIG. 1, first paper conveying section 4 is provided at the left of paper cassette 3 in main body 2. As shown, first paper conveying section 4 may be disposed substantially vertically along the left side of main body 2. First paper conveying section 4 receives the paper P fed out from paper cassette 3 and conveys paper P vertically upward along the left side of main body 2 to transfer unit 30. In some embodiments, first paper conveying section 4 may receive paper P fed from other components of the printer including, but not limited to conveying paths, cassettes, trays and/or any component known in the art. For example, first paper conveying section 4 may receive paper P from 2-sided paper conveying path 15.

Some embodiments may include manual paper feeding unit 5 provided above paper cassette 3 and at the right side of main body 2 opposite the left side at which first paper conveying section 4 is disposed. In each of various embodiments, positioning of the components may vary. In some embodiments, manual paper feeding unit 5, may manually feed paper one sheet at a time. Feeding paper manually may be used for materials of different sizes, (materials having e.g., size not for the paper cassette 3), thick papers, envelopes, and/or overhead projector (OHP) sheets.

As shown in FIG. 1, some embodiments may include second paper conveying section 6 may be provided at the left of manual paper feeding unit 5. Second paper conveying section 6 is located just above paper cassette 3 and extends from manual paper feeding unit 5 substantially horizontally to first paper conveying section 4 and couples to first paper conveying section 4. Second paper conveying section 6 may receive paper P or the like, fed from manual paper feeding unit 5 and convey it substantially horizontally to first paper conveying section 4.

In some embodiments, document conveying unit 7 may be provided on the top of main body 2 of image forming apparatus 1, and image reader 8 provided therebelow. When a user copies documents, the user may position the documents which include images (e.g., characters, figures, and/or patterns) to be copied on document conveying unit 7. In some embodiments, document conveying unit 7 feeds the documents one by one, and image reader 8 reads the image data.

The reading of document images and/or the start of printing, may be executed using an operation panel (not shown) provided on the top of main body 2 and at front of the image reader 8. The user can input print conditions, such as the size of paper to be used, scaling, and whether to execute two-sided printing, on the operation panel. In some embodiments, the operational panel may be positioned at another location on the main body. An embodiment may include a control panel external to the main body, for example, positioned on a wall proximate the image forming apparatus, a virtual control panel on a computer and/or combinations thereof.

Information of the image data of the documents is sent to exposure unit 9 disposed above second paper conveying section 6 and in the center of main body 2 as shown in FIG. 1. Exposure unit 9 emits the laser beam L that is controlled on the basis of the image data toward image forming unit 20.

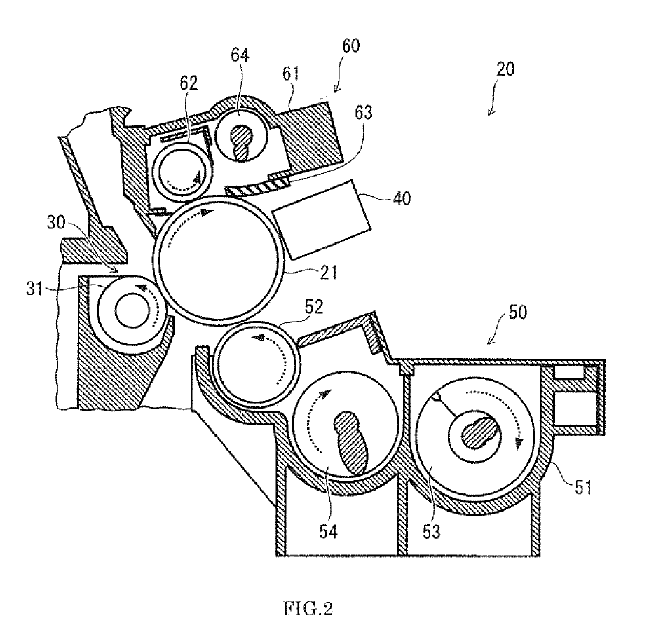

In some embodiments, image forming unit 20 and transfer unit 30 are provided above first paper conveying section 4 and at the left of exposure unit 9. In an embodiment of image forming unit 20, an electrostatic latent image of each document image may be formed on photosensitive drum 21, shown in FIG. 2. In some embodiments, the electrostatic latent image may be formed with the laser beam L emitted from exposure unit 9 as shown in FIG. 2. An embodiment may include developing the electrostatic latent image into a toner image on photosensitive drum 21. As shown in FIG. 1, toner may be supplied to image forming unit 20 from toner container 10 provided above exposure unit 9. The positioning of the toner container, exposure unit and image forming unit may vary in some embodiments. The toner image formed on photosensitive drum 21 of image forming unit 20 may be transferred by transfer unit 30 onto the paper P. This transfer may occur prior to feeding an additional sheet or paper by first paper conveying section 4.

An embodiment may include fixing unit 11 provided above transfer unit 30. In some embodiments, positioning of the components may vary. For example, a fixing unit may be positioned at various locations relative to the transfer unit. In some embodiments, paper P that bears the unfixed toner image at transfer unit 30 may be fed to fixing unit 11. At the fixing unit the toner image may be heated by a heat roller and may be pressed by a pressure roller for fixation.

In some embodiments, branching section 12 may be provided above fixing unit 11. If two-sided printing is not performed, paper P discharged from fixing unit 11 is output from branching section 12 to in-body paper output unit 13 provided in the body of image forming apparatus 1.

As shown in FIG. 1, an embodiment may include an output port through which the paper P is output from branching section 12 toward in-body paper output unit 13. In some embodiments, this output port may also function as switch-back section 14. In an embodiment carrying out two-sided printing, the conveying direction of the paper P discharged from fixing unit 11 may be switched by switch-back section 14. As depicted in FIG. 1, the paper P may pass through branching section 12, be fed downward through a two-sided-printing paper conveying path 15 provided at the left of the fixing unit 11 and at the left of the transfer unit 30, and be fed again to the transfer unit 30 through first paper conveying section 4.

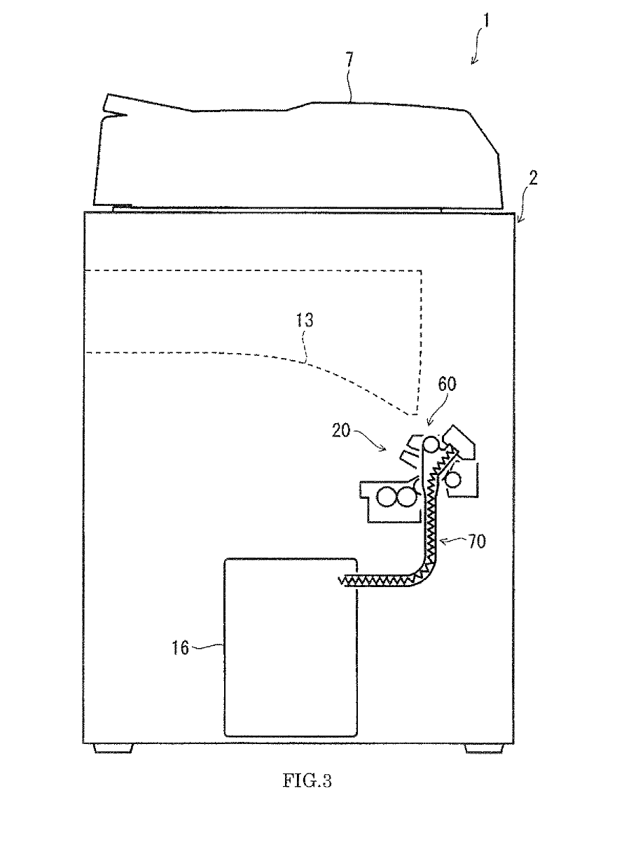

An embodiment of the configuration of the image forming unit 20 of the image forming apparatus 1 will be described with reference to FIGS. 2 and 3 in addition to FIG. 1. FIG. 2 depicts an enlarged view of a front vertical section of image forming unit 20. FIG. 3 is a schematic view of a vertical section of the back of image forming apparatus 1.

As shown in FIG. 2, image forming unit 20 may be provided with photosensitive drum 21, positioned proximate the center, serving as an image bearing member. In some embodiments, charging unit 40, developing unit 50, and cleaning unit 60 are disposed in the vicinity of the photosensitive drum 21. The units may be arranged so that a point on the photosensitive drum contacts the units in a specific order during rotation. For example, as FIG. 2 depicts the units may be arranged such that the order of contact starting from a point proximate charging unit 40 may be developing unit 50, transfer unit 30, and cleaning unit 60.

In some embodiments, photosensitive drum 21 may extend along the width of paper P perpendicular to the direction of paper conveyance in image forming apparatus 1. For example, photosensitive drum 21, as depicted in FIG. 2, may extend in the direction perpendicular to the plane of FIG. 2. In some embodiments, photosensitive drum 21 may be an inorganic photoreceptor drum. An embodiment of the photosensitive drum may include a photosensitive layer made of inorganic photoconductive amorphous silicon formed on the outside of an electrically conductive roller member. In some embodiments, the electrically conductive roller member may be made of electrically conductive materials including, but not limited to aluminum or the like. An embodiment may include depositing the photosensitive layer by vacuum deposition or the like. In some embodiments, the photosensitive drum may be rotated by a driving unit (not shown) so that the peripheral speed thereof becomes substantially the same as a paper conveying speed. The peripheral speed of the photosensitive drum and the paper conveying speed may in a range from about 75 mm/s to about 440 mm/s in various embodiments. In some embodiments, the peripheral speed of the photosensitive drum and the paper conveying speed may in a range from about 100 mm/s to about 200 mm/s. An embodiment may include using a peripheral speed of the photosensitive drum and a paper conveying speed in a range from about 112 mm/s to about 138 mm/s. For example, both the peripheral speed of the photosensitive drum and the paper conveying speed may be about 125 mm/s.

In some embodiments, the charging unit may include, but is not limited to a scorotron charging unit, a corotron charging unit, a contact charging unit, any other charging unit known in the art and/or combinations thereof. As shown in FIG. 2, charging unit 40 is a scorotron charging unit that uses a corona discharger. In some embodiments, a corotron charging unit using a corona discharger may be utilized. An embodiment of a charging unit may include a contact charging unit using a roller, a brush, or the like. The charging unit may uniformly charge the surface of the photosensitive drum to a pre-determined polarity and/or pre-determined potential.

As shown in FIG. 2, an embodiment of developing unit 50 may include developing roller 52 in housing 51. In some embodiments, developing roller 52 may utilize a developing method using a magnetic jumping phenomenon and may be provided in the vicinity of photosensitive drum 21. In some embodiments, a bias voltage with the same polarity as a polarity charged on photosensitive drum 21 is applied to developing roller 52. An embodiment may include toner serving as a developer charged by developing roller 52 and moved to an electrostatic latent image on the surface of photosensitive drum 21, so an electrostatic latent image is developed.

In some embodiments, toner utilized may include, but is not limited to polymers, such as a styrene acrylate copolymer, a polyester resin, a styrene butadiene copolymer, polymers known in the art and/or combinations thereof, toner components known or yet to be discovered in the art, and/or combinations thereof. For example, an embodiment may include a styrene-acryl magnetic powder toner. As shown in FIG. 1, toner may be stored in toner container 10. In some embodiments, toner container 10 may be coupled to housing 51 of developing unit 50. In an embodiment, toner may be supplied from toner container 10 to first stirring conveying member 53 positioned within housing 51. In some embodiments, multiple stirring conveying members may be positioned proximate each other. As shown in FIG. 2, housing 51 accommodates second stirring conveying member 54 positioned proximate first stirring conveying member 53. Stirring conveying members 53, 54 may be used to convey the toner to developing roller 52 while stirring the toner. In some embodiments, the developing method of the developing unit may vary from the above described method and may include methods or portions of methods known in the art. Toners utilized may include multiple-component developers, such as a two-component developer.

As shown in FIG. 2, transfer unit 30 may be provided with transfer roller 31 serving as a transfer member. In some embodiments, transfer roller 31 may be in contact with photosensitive drum 21 from the left in FIG. 2 to form a transfer nip through which paper P is passed. The contact point between the photosensitive drum and the transfer roller may be in pressure contact in some embodiments. An embodiment may include transfer roller 31 which rotates with the rotation of photosensitive drum 21 by coming into contact with photosensitive drum 21 without a driving unit. In some embodiments, transfer roller 31 may have a pre-determined transfer bias with a polarity different from the polarity charged on photosensitive drum 21 and the toner.

As shown in FIG. 2, an embodiment may include cleaning unit 60 disposed downstream of transfer unit 30 along the rotating direction of photosensitive drum 21 and above photosensitive drum 21. In some embodiments, as depicted in FIG. 2 cleaning unit 60 includes cleaning roller 62, cleaning blade 63, toner discharge screw 64, and toner conveying mechanism 70 (See FIG. 3) positioned, at least partially, within housing 61. In some embodiments, the toner conveying mechanism may be positioned outside of the housing. An embodiment may include a discharging screw which discharges toner to the toner conveying mechanism positioned outside of the housing.

In some embodiments, cleaning roller 62 and cleaning blade 63 may be biased by an elastic member (not shown), such as a spring, against photosensitive drum 21. An embodiment of cleaning roller 62 and cleaning blade 63 extend in the axial direction of photosensitive drum 21 and have substantially the same axial length as photosensitive drum 21.

To clean the surface of the photosensitive drum with high efficiency, the cleaning roller may be rotated by a driving unit such that the movement of both the photosensitive drum and the cleaning roller are in the same direction at their contact point. As shown in FIG. 2, the surface of cleaning roller 62 in contact with photosensitive drum 21 moves in the same direction as the surface of the photosensitive drum 21. In some embodiments, the cleaning roller and the photosensitive drum may move at different speeds. For example, the cleaner roller may be rotated so that the peripheral speed of the cleaner roller is about 15 to 20% higher than the peripheral speed of the photosensitive drum. In some embodiments, cleaning roller 62 may remove and/or collect adherents, such as residual toner, from the surface of photosensitive drum 21. In some embodiments, cleaner roller 62 may grind the surface of photosensitive drum 21 with toner containing abrasive sticking to the surface of cleaning roller 62. In an embodiment, cleaning blade 63 may clean the surface of the photosensitive drum 21. For example, the cleaning blade may scrape adherents, such as toner, remaining on the surface of the photosensitive drum.

In some embodiments, toner discharge screw 64 is a rotating member that rotates about the axis substantially parallel to the axis of cleaning roller 62 and extends from the interior of housing 61 to toner conveying mechanism 70 (see FIG. 3) provided on the back of main body 2 outside image forming unit 20. In some embodiments, toner discharge screw 64 may play a role in discharging materials (e.g., waste toner, etc.) removed from the surface of photosensitive drum 21. These materials may be discharged to the exterior of housing 61. For example, the materials may be discharged to toner conveying mechanism 70. In some embodiments, some of the materials discharged may have been used for cleaning a portion of the photosensitive drum.

In some embodiments, toner conveying mechanism 70 may be provided on the back of main body 2 of the image forming apparatus 1, as shown in FIG. 3. As shown in FIG. 3, some embodiments may include toner conveying mechanism 70 extending downward from cleaning unit 60. For example, in some embodiments, toner conveying mechanism 70 may extend downward from cleaning unit 60 at a location corresponding to toner discharge screw 64 (shown in FIG. 2). As shown in FIG. 3, waste-toner collecting container 16 may be provided at the lower end of toner conveying mechanism 70. In some embodiments, toner conveying mechanism 70 may play a role in conveying the waste toner collected by cleaning unit 60 and discharged from housing 61 of cleaning unit 60 by toner discharge screw 64 to waste-toner collecting container 16.

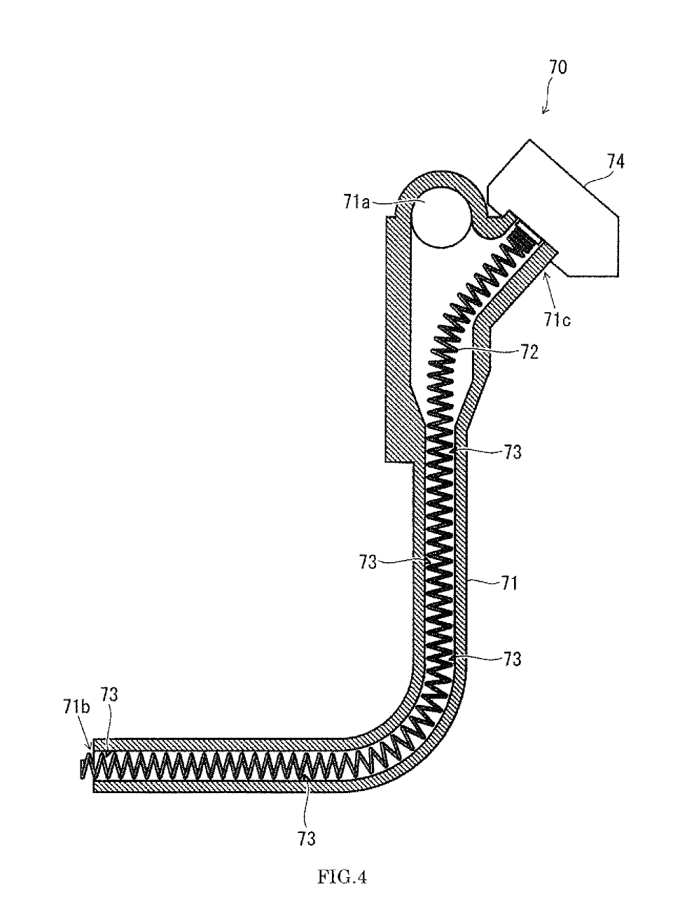

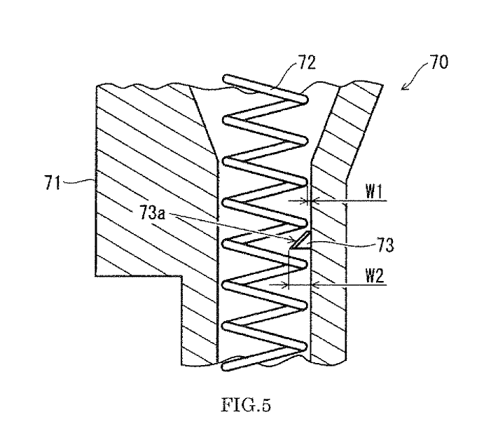

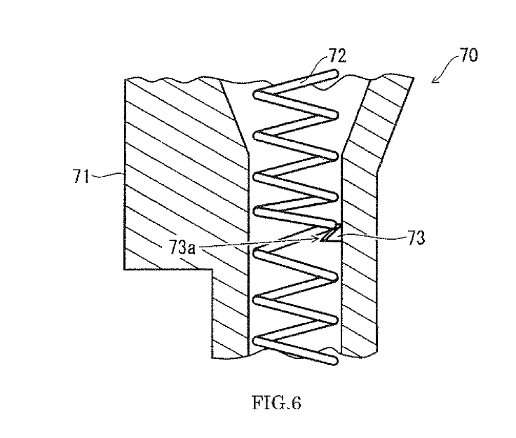

Embodiments of the toner conveying mechanism 70 will be described with reference to FIGS. 4 to 6 in addition to FIGS. 2 and 3. FIG. 4 is view of a vertical section of the back of toner conveying mechanism 70; FIG. 5 is a partially enlarged view of a vertical section of the back of the toner conveying mechanism 70; and FIG. 6 is a partially enlarged view of a vertical section of the back of toner conveying mechanism 70 as is depicted in FIG. 5, showing a state in which conveying spiral 72 is in contact with protrusion 73.

As shown in FIG. 4, an embodiment may include toner conveying mechanism 70 provided with conveying spiral 72. In some embodiments, the conveying spiral may serve as a waste-toner conveying member. As shown in FIG. 4, some embodiments may include a toner conveying mechanism which includes protrusions 73 in housing 71 and driving mechanism 74.

As shown in FIG. 4, housing 71 may be shaped substantially like a pipe. In some embodiments, the housing may be configured as a waste-toner containing conveying path. As shown in FIG. 3, housing 71 extends from the upstream portion in the toner conveying direction substantially vertically downward, curves substantially at right angles at the downstream portion, and extends substantially horizontally to waste-toner collecting container 16. In some embodiments, toner inlet port 71a for receiving waste toner sent by toner discharge screw 64 (shown in FIG. 2) is provided at the upstream end of housing 71. Embodiments may include toner outlet port 71b for discharging the waste toner toward waste-toner collecting container 16 provided at the downstream end. Some embodiments include motor connecting port 71c branching from the waste-toner conveying path provided in the vicinity of toner inlet port 71a.

As shown in FIG. 4, some embodiments include conveying spiral 72 in the shape of a spring and disposed in housing 71. The conveying spiral may include, but is not limited to a spring, any geometry in which toner can be conveyed by rotation, such as a spiral or a screw or other geometries known in the art. Conveying spiral 72 may extend from driving mechanism 74 mounted at motor connecting port 71c of housing 71 to toner outlet port 71b in some embodiments. An embodiment may include at least a portion of the conveying spiral curving. For example, the section of the conveying spiral between driving mechanism and the toner outlet port may be curved. In some embodiments, conveying spiral 72 may be joined to driving mechanism 74 at the upstream end and may be free at the downstream end. This configuration may allow conveying spiral 72 to be rotated when driving mechanism 74 is driven. In some embodiments, conveying spiral 72 may rotate in a direction in which the waste toner in housing 71 is fed to waste-toner collecting container 16, so the waste toner can be conveyed to waste-toner collecting container 16.

As shown in FIG. 4, protrusions 73 may be provided on the inner wall of housing 71. As shown in FIG. 5, protrusions 73 protrude from the inner wall of housing 71 toward the axial center of housing 71. In some embodiments, protrusions may protrude from the inner wall of the housing toward conveying spiral 72. Some embodiments may include protrusions having varying geometries including, but not limited to any regular shape (e.g., rectangular, triangular, cylindrical, etc.), an irregular shape (e.g., polygons, etc.), inclined surfaces, curved surfaces, any known baffle construction, and/or combinations thereof. As depicted in FIG. 5, protrusions 73 may each have an inclined surface 73a, at the end extending away from the inner wall of housing 71. In some embodiments, inclined surface 73a may increase from the upstream side to the downstream side in the toner conveying direction. As shown in FIG. 5, some embodiments may include protrusions 73 configured so that gap “W1” defined as the distance between the outer circumference of conveying spiral 72 and the inner wall surface of housing 71 is smaller than the distance “W2” from the inner wall surface of housing 71 to the ends of protrusions 73.

In some embodiments, rotation of the conveying spiral may allow a portion of the protrusion to contact a portion of the conveying spiral. FIG. 5 depicts a state in which conveying spiral 72 is out of contact with protrusions 73. The conveying spiral may be rotate from the state shown in FIG. 5, such that conveying spiral 72 comes into contact with protrusion 73, as shown in FIG. 6. In some embodiments, due to the spring shape, conveying spiral 72 is caught on protrusions 73 after coming into contact therewith and is thus kept in contact with the protrusions for a while against the elastic force thereof.

In some embodiments, portions of conveying spiral 72 in contact with protrusions 73 may, in some embodiments, “catch” on protrusions 73 as shown in FIG. 6. In some embodiments, the conveying spiral may return to the state shown in FIG. 5, when a portion of the conveying member slips on an inclined surface of the protrusions. In some embodiments, the conveying spiral may have a small diameter which allows the conveying spiral to return to the state depicted in FIG. 5. In some embodiments when conveying spiral 72 returns to the state depicted in FIG. 5, the conveying spiral may vibrate violently due to the action of an elastic force caused by the catch. Thus, in some embodiments conveying spiral 72 may be vibrated by coming into intermittent contact with protrusions 73 during rotation. Some embodiments may include portions of conveying spiral 72 in contact with protrusions 73 passing over protrusions 73 vigorously from the upstream side to the downstream side in the toner conveying direction, which promotes conveyance of the toner.

As described above, use of protrusions positioned on the inner surface of the housing provides a mechanism for forcibly vibrating the conveying spiral close to the conveying spiral in the housing. Providing a mechanism to vibrate the conveying spiral in close proximity to the conveying spiral may reduce and/or inhibit impact sound due to the vibration of the conveying spiral from echoing to the exterior of the housing. In some embodiments, vibrating the conveying spiral in the manner described herein may reduce and/or inhibit an amount of toner on the conveying spiral. Thus, a toner conveying mechanism can be provided in which the deposition of toner on the conveying spiral can be reduced and/or inhibited without generating noise. In some embodiments, the toner conveying mechanism described can maintain a toner conveying function in a pre-determined range of values.

As shown in FIG. 5, gap W1 is defined as the distance between the outer circumference of conveying spiral 72 and the inner wall surface of housing 71 and distance W2 is defined as the distance between the inner wall surface of housing 71 and the upper end of protrusion 73. In some embodiments, when gap W1 is smaller than distance W2, conveying spiral 72 may contact with protrusions 73 more regularly. Thus, a toner conveying mechanism may be provided in which the action of vibrating the conveying spiral to reduce and/or inhibit toner from depositing on the conveying spiral may be increased, so that the toner conveying function is improved.

In an embodiment, utilizing protrusions having inclined surfaces may allow for sufficient vibratory action of the conveying spiral to reduce and/or inhibit deposition of toner on the conveying spiral. As shown in FIGS. 5-6, protrusions 73 each have inclined surface 73a, at the end extending away from the inner wall of housing 71 from the upstream side to the downstream side in the toner conveying direction. In some embodiments, this configuration may allow the vibrating action of conveying spiral 72, (i.e., the conveying spiral coming into and out of contact with protrusions 73) to be achieved in a controlled manner. Utilizing this configuration may reduce an amount of wear caused by repeated use to conveying spiral 72 and protrusions 73. Thus, the toner conveying mechanism provided may reduce and/or inhibit deposition of toner on the conveying spiral while reducing an amount of noise generated during use, and maintaining a toner conveying function. In some embodiments, the toner conveying function may be maintained at a pre-determined rate.

In some embodiments, protrusions may be provided at a plurality of locations along the length of the housing and/or at a plurality of azimuthal locations about the longitudinal axis of the housing. As shown in FIG. 4, protrusions 73 are provided at a plurality of locations, and conveying spiral 72 can be vibrated at the plurality of locations. As shown in FIG. 4, even if conveying spiral 72 is relatively long, conveying spiral 72 can be vibrated at many locations. In some embodiments, a toner conveying mechanism can be provided in which the action of reducing and/or inhibiting toner from depositing on the conveying spiral 72 is enhanced, so that toner conveying function can be maintained.

As shown in FIG. 3, an embodiment may include providing toner conveying mechanism 70 at cleaning unit 60. An embodiment may include providing cleaning unit 60 in which the deposition of toner on the conveying spiral 72 can be reduced and/or inhibited while noise generated during use is reduced, so that a waste-toner conveying function can be maintained.

In some embodiments, toner conveying mechanism 70 may be provided in image forming apparatus 1 as shown in FIG. 3. Therefore, a reliable image forming apparatus can be provided in which the deposition of toner on the conveying spiral can be reduced and/or inhibited while reducing noise generated during use, so that a toner conveying function can be maintained. In some embodiments, the toner conveying function may be maintained within a pre-determined range.

While the present invention has been described with reference to one or more embodiments, it is to be understood that the scope of the present invention is not limited thereto and that various modifications can be made without departing from the spirit of the invention.

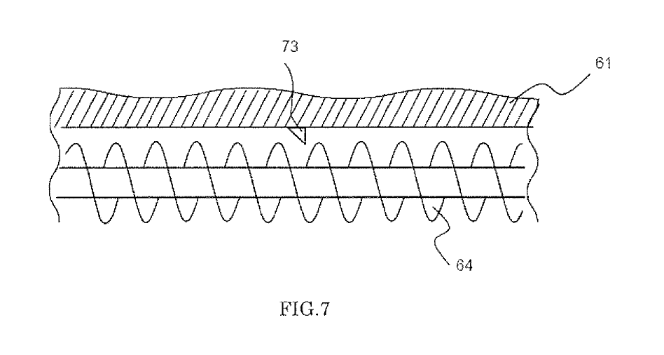

As shown in FIG. 3, some embodiments include providing toner conveying mechanism 70 mounted on cleaning unit 60 provided in image forming unit 20 of image forming apparatus 1 for conveying the waste toner to waste-toner collecting container 16. In some embodiments, the location at which toner conveying mechanism 70 can be mounted may vary. For example, the toner conveying mechanism may be mounted to toner discharge screw 64. As is depicted in FIG. 7, protrusions may be provided on a wall of housing 61 so as to intermittently contact toner discharge screw 64 during rotation, so that the deposition of the toner on the toner discharge screw 64 can be reduced and/or inhibited. This may allow the toner conveying (discharging) function to be maintained. For example, protrusions may be provided on the inner wall of housing 61 so as to intermittently contact toner discharge screw 64 during rotation, so that the deposition of the toner on toner discharge screw 64 can be reduced and/or inhibited.

In some embodiments, a toner conveying mechanism may be mounted to developing unit 50 of image forming unit 20 (shown in FIG. 2) to stir and convey the toner. In this case, protrusions may intermittently contact with first stirring conveying member 53 and/or second stirring conveying member 54 with the rotation thereof, so that the deposition of the toner on first stirring conveying member 53 and/or second stirring conveying member 54 can be reduced and/or inhibited. In some embodiments, this configuration may allow the toner (stirring) conveying function to be maintained. In some embodiments, a toner conveying mechanism 70, as shown in FIG. 4, may be mounted to a device other than an image forming apparatus.

In an embodiment, the image forming apparatus equipped with the toner conveying mechanism is a monochrome printing image forming apparatus that uses only black toner. Some embodiments may include an image forming apparatus including, but not limited to a color-printing image forming apparatus of a tandem type or a rotary rack type equipped with an intermediate transfer belt and capable of image formation by superimposing a plurality of colors utilizing the toner conveying mechanism.

Flaying thus described in detail embodiments of the present invention, it is to be understood that the invention defined by the foregoing paragraphs is not to be limited to particular details and/or embodiments set forth in the above description, as many apparent variations thereof are possible without departing from the spirit or scope of the present invention.

What is claimed is:

1. A toner conveying mechanism comprising:
a housing;
a conveying member disposed in the housing and configured to convey toner within the housing by rotation; and
a protrusion disposed on the surface of the inner wall of the housing and protruding toward the conveying member,
wherein the conveying member and the protrusion are configured such that the conveying member intermittently contacts the protrusion during rotation of the conveying member.

2. The toner conveying mechanism according to claim 1, wherein the distance between the outer circumference of the conveying member and the surface of the inner wall of the housing is smaller than the distance between the inner wall surface of the housing and an outermost portion of an end of the protrusion.

3. The toner conveying mechanism according to claim 1, wherein the end of the protrusion has an inclined surface that extends away from the surface of the inner wall of the housing from the upstream side to the downstream side in a toner conveying direction.

4. The toner conveying mechanism according to claim 1, wherein the protrusion is disposed at a plurality of locations on the surface of the inner wall of the housing.

5. A cleaning unit comprising:
a cleaning member configured to remove toner from a photoreceptor;
a housing configured to receive the toner removed by the cleaning member;
a conveying member disposed in the housing and configured to convey the toner by rotation; and
a protrusion disposed on the surface of the inner wall of the housing and protruding toward the conveying member,
wherein the conveying member and the protrusion are configured such that the conveying member intermittently contacts the protrusion during rotation of the conveying member.

6. An image forming apparatus comprising:
a photoreceptor on which an electrostatic latent image is formed based on a document image;
a developing unit configured to form a toner image on the photoreceptor by developing the electrostatic latent image formed on the photoreceptor with toner;
a transfer unit configured to transfer the toner image formed on the photoreceptor by the developing unit to a recording medium;
a cleaning member configured to remove the toner remaining on the photoreceptor from the photoreceptor after the toner image is transferred to the transfer unit;
a housing configured to receive the toner removed by the cleaning member;
a conveying member disposed in the housing and configured to convey the toner by rotation; and
a protrusion disposed on the surface of the inner wall of the housing and protruding toward the conveying member,
wherein the conveying member and the protrusion are configured such that the conveying member intermittently contacts the protrusion during rotation of the conveying member.

7. A toner conveying mechanism comprising:
a housing;
a conveying member configured to convey toner within the housing; and
a protrusion disposed on the surface of the inner wall of the housing and protruding toward the conveying member,
wherein the conveying member and the protrusion are configured such that the conveying member intermittently contacts the protrusion.

8. The toner conveying mechanism according to claim 7, wherein the distance between the outer circumference of the conveying member and the surface of the inner wall of the housing is smaller than the distance between the inner wall surface of the housing and an outermost portion of an end of the protrusion.

9. The toner conveying mechanism according to claim 7, wherein the end of the protrusion has an inclined surface that extends away from the surface of the inner wall of the housing from the upstream side to the downstream side in a toner conveying direction.

10. The toner conveying mechanism according to claim 7, wherein the protrusion comprises one or more protrusions disposed at a plurality of locations on the surface of the inner wall of the housing.

11. The toner conveying mechanism according to claim 7, wherein the conveying member and the protrusion are configured such that the conveying member intermittently contacts the protrusion during rotation of the conveying member.
